(19) United States
(12) Patent Application Publication
(10) Pub. No.: US 2008/0289146 A1
(43) Pub. Date: Nov. 27, 2008

(54) Hidden type of hinge structure

(76) Inventor: Shun-Tzu Chen, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/802,269

(22) Filed: May 22, 2007

(51) Int. Cl. E05D 7/00

(52) U.S. Cl. 16/372

(57) ABSTRACT

A hinge includes first and second holders, which are fixedly inserted in a doorframe and a door plank respectively, and a hinge pivoting the holders together; the hinge includes several first and second bent arms, which have first and second holes on two tail ends, and an intermediate hole; a pivotal pin is passed through the intermediate holes; another pin is passed through the first holes of the first arms to pivot the first arms to the first holder; yet another pin is passed through the first holes of the second arms to pivot the second arms to the second holder; a sliding pin is passed through the second holes of the first arms and passed into opposing upper and lower slots of the second holder; a second sliding pin is passed through the second holes of the second arms and passed into opposing slots of the first holder.

### BACKGROUND OF THE INVENTION

1. Field of the Invention

The present invention relates to a hidden type of hinge structure, more particularly one, which can be accurately installed with ease, and which will move smoothly when the door plank is being pivoted.

2. Brief Description of the Prior Art

A door plank is coupled to a doorframe with hinges so as to swing between an open position and a close one. Referring to FIG. 6, a currently existing hinge structure includes two hinges 91. Each of the hinges 91 comprises a pivotal part 912, and two connecting plates 911, which are joined to the pivotal part 912 so as to pivot relative to each other, and are securely joined to a doorframe 93, and a door plank 92 respectively; one of the hinges 91 is disposed near to a lower end of the door plank 92, and the other near to an upper end in order to increase stableness of the door plank 92.

In installation, both the hinges 91 have to be positioned in such a manner that the pivotal parts 912 are aligned on a vertical line-otherwise the door plank 92 will be subjected too much friction when pivoting to/away from the shut position, and it can even be hindered from pivoting to/away from the shut position by the doorframe 93 Furthermore, the edges of the door plank 92 won't be able to be closely in touch with the doorframe 93 after the door plank 92 is shut. However, it takes relatively much labor and time to make the pivotal parts 912 of the hinges 91 accurately aligned on a vertical line in installation, and it will be relatively difficult for a person to adjust the hinges 91 if he fails to place the hinges in a proper position.

### SUMMARY OF THE INVENTION

It is a main object of the present invention to provide an improvement on a hinge structure to overcome the above problems.

A hinge structure according to an embodiment of the present invention includes first and second holding members, which are inserted in and secured to a doorframe and a door plank respectively, and a hinge pivoting the holding members together. The hinge includes several first and second swinging bent arms, which have first and second holes on two tail ends, and an intermediate hole. A connecting pin is passed through the intermediate holes so as to pivot the arms together. A first pivotal pin is passed through the first holes of the first arms to pivot the first arms to the first holding member while a second pivotal pin is passed through the first holes of the second arms to pivot the second arms to the second holding member. A first sliding pin is passed through the second holes of the first arms and passed into opposing upper and lower slots of the second holding member while a second sliding pin is passed through the second holes of the second arms and passed into opposing slots of the first holding member; thus, the door plank can be pivoted on the doorframe between a closed position and an opened one with the first arms pivoting on the first pivotal pin, the second arms pivoting on the second pivotal pin, and with the sliding pins moving on the corresponding slots. Furthermore, the hinge will be hidden within the door plank and the doorframe after the door plank is closed.

### BRIEF DESCRIPTION OF THE DRAWINGS

The present invention will be better understood by referring to the accompanying drawings, wherein:

FIG. 1 is a fragmentary exploded perspective view of the hinge of the present invention,

FIG. 2 is a front sectional view of the present invention,

FIG. 3 is a front view of the present invention,

FIG. 4 is a horizontal sectional view, taken after the hinge is fitted on a door plank and a doorframe, and the door plank is opened,

FIG. 5 is a horizontal sectional view, taken after the hinge is fitted on a door plank and a doorframe, and the door plank is closed, and

FIG. 6 is a front view of the prior art.

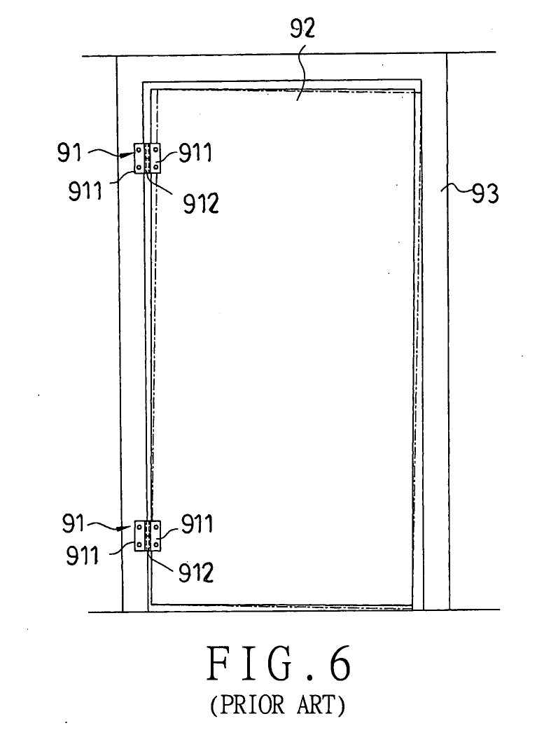

### DETAILED DESCRIPTION OF THE PREFERRED EMBODIMENTS

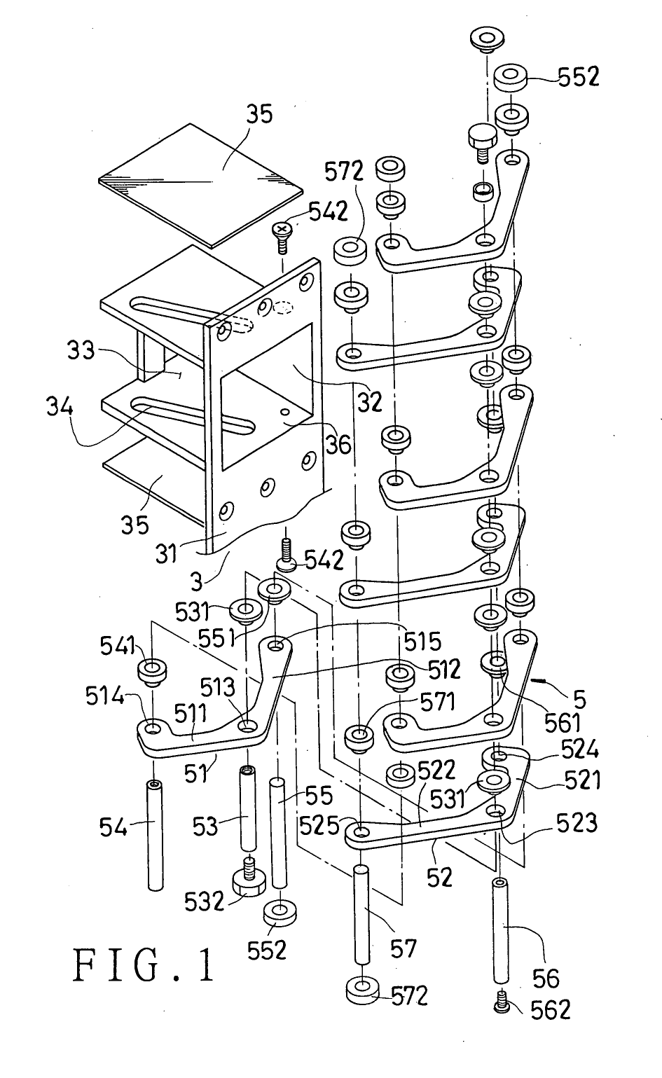

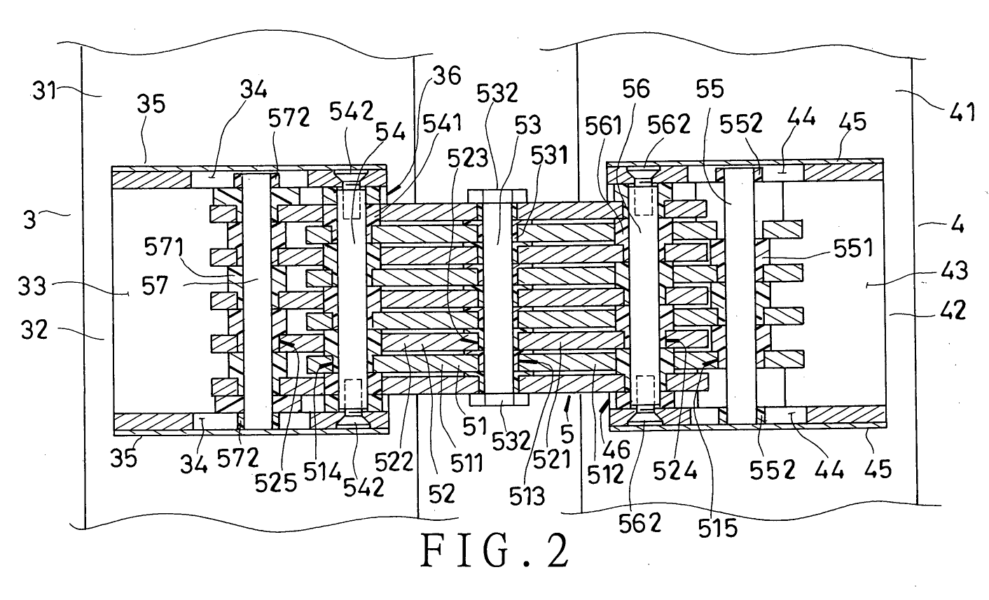

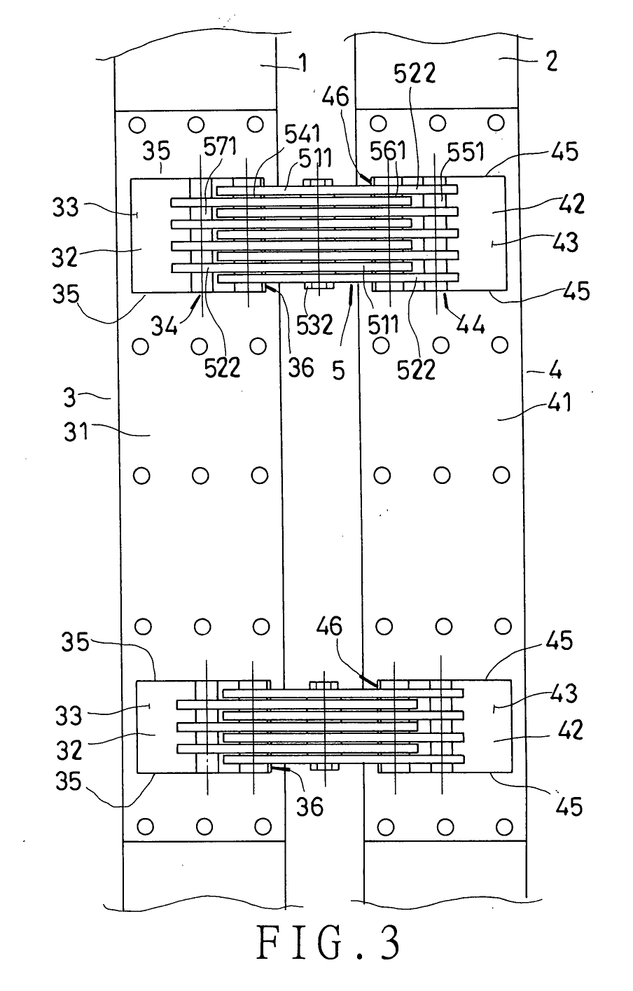

Shown in FIGS. 1, 2, and 3 is a preferred embodiment of a hidden type of hinge structure of the present invention, which is used to pivot a door plank 2 to a doorframe 1. The hidden hinge structure includes:

(a) a first holding member 3 joined to the doorframe 1, the first holding member 3 comprises a connecting panel 31 secured on the doorframe 1, and several hollow holding portions 32, which are arranged one on top of another next to one side of the connecting panel 31, and which are inserted in a space in the doorframe 1; each of the hollow holding portions 32 has a receiving room 33 therein; the connecting panel 31 has several holes 36 thereon, which are faced and in open communication with the receiving rooms 33 of the hollow holding portions 32 respectively; each of the hollow holding portions 32 has two slots 34, which are formed on a top and a bottom of the hollow holding portion 32 respectively so as to face each other, and which are faced and in open communication with a corresponding said receiving room 33; the first holding member 3 further comprises connecting plate members 35, which are arranged on the top and the bottom of each of the hollow holding portions 32;

(b) a second holding member 4 joined to the door plank 2, the second holding member 4 has the same shape as the first one 3, comprising a connecting panel 41 secured on the door plank 2, and several hollow holding portions 42, which are arranged one on top of another next to one side of the connecting panel 41, and which are inserted in a space in the door plank 2; each of the hollow holding portions 42 has a receiving room 43 therein; the connecting panel 41 has several holes 46 thereon, which are faced and in open communication with the receiving rooms 43 of the hollow holding portions 42 respectively; each of the hollow holding portions 42 has a slot 44 on each of a top and a bottom thereof, which is faced and in open communication with a corresponding said receiving room 43; the second holding member 4 further comprises connecting plate members 45, which are arranged on the top and the bottom of each of the hollow holding portions 42; and

(c) several hinges 5 pivoting the first and the second holding members 3 and 4 together; the hinges 5 are each partly received in one of the hollow holding portions 32, and partly received in one of the hollow holding portions 42; each of the hinges 5 includes:

several first swinging bent arms 51; each of the first swinging bent arms 51 has a short section 511, a long section 512, a first receiving hole 514 on a tail end of the short section 511, and a second receiving hole 515 on a tail end of the long section 512 thereof;

several second swinging bent arms 52; each of the second swinging bent arms 52 has a short section 521, a long section 522, a third receiving hole 524 on a tail end of the short section 521, and a fourth receiving hole 525 on a tail end of the long section 522; in addition, each of the first and the second swinging bent arms 51, 52 has a connecting hole 513, 523, which is formed on a joint between the short section 511, 521 and the long section 512, 522;

the first swinging bent arms 51 are overlapped with and intersect the second swinging bent arms 52 such that all of the connecting holes 513 and 523 are on a straight line; in addition, the first swinging bent arms 51 are arranged such that every two close ones of the connecting holes 513 of the first swinging bent arms 51, which are close to each other, have one said connecting hole 523 intervening between them; furthermore, the first receiving holes 514 of the first swinging bent arms 51 are on a straight line, the second receiving holes 515 are on a straight line, the third receiving holes 524 of the second swinging bent arms 52 are on a straight line, and the fourth receiving holes 525 are on a straight line;

a connecting pin 53 passed through the connecting holes 513 and 523 of the first and the second swinging bent arms 51 and 52 to pivot the first and the second swinging bent arms 51 and 52 together; the connecting pin 53 is securely joined to threaded elements 532 at two ends thereof; there are several first ringed pads 531 positioned around the connecting pin 53, which are each interposed between two said connecting holes 513, 523 of the first and the second swinging bent arms 51 and 52, and passed into one of the corresponding connecting holes 513 and 523 at a small-diameter section thereof;

a first pivotal pin 54 pivoting the first swinging bent arms 51 to the first holding member 3; the first pivotal pin 54 is passed through the first receiving holes 514 of the first swinging bent arms 51, and securely joined at two ends thereof to the top and the bottom of one said hollow holding portion 32 of the first holding member 3 by means of threaded elements 542; there are several second ringed pads 541 positioned around the first pivotal pin 54, which are each interposed between two adjacent ones of the first receiving holes 514 of the first swinging bent arms 51, and passed into one of said corresponding first receiving holes 514 at a small-diameter section thereof;

a first sliding pin 55, the first sliding pin 55 is passed at two ends thereof into the slots 44 of the top and the bottom of one corresponding said hollow holding portion 42 of the second holding member 4, and passed through the second receiving holes 515 of the first swinging bent arms 51 so as to serve as a pivot of the first swinging bent arms 51; there are several third ringed pads 551 positioned around the first sliding pin 55, which are each interposed between two adjacent ones of the second receiving holes 515 of the first swinging bent arms 51, and passed into one of said corresponding second receiving holes 515 at a small-diameter section thereof; furthermore, there are two sliding sleeves 552 provided to the present structure, which are positioned around two ends of the first sliding pin 55 respectively, and received in the slots 44 in a movable manner in order for allowing the long sections 512 of the first swinging bent arms 51 to be moved on the slots 44 together with the first sliding pin 55;

a second pivotal pin 56 pivoting the second swinging bent arms 52 to the second holding member 4; the second pivotal pin 56 is passed through the third receiving holes 524 of the second swinging bent arms 52, and securely joined at two ends thereof to the top and the bottom of a corresponding said hollow holding portion 42 of the second holding member 4 by means of threaded elements 562; there are several fourth ringed pads 561 positioned around the second pivotal pin 56, which are each interposed between two adjacent ones of the third receiving holes 524, and passed into one of said corresponding third receiving holes 524 at a small-diameter section thereof;

a second sliding pin 57, the second sliding pin 57 is passed at two ends thereof into the slots 34 of the top and the bottom of one corresponding said hollow holding portion 32 of the first holding member 3, and passed through the fourth receiving holes 525 of the second swinging bent arms 52 so as to serve as a pivot of the second swinging bent arms 52; there are several fifth ringed pads 571 positioned around the second sliding pin 57, which are each interposed between two adjacent ones of the fourth receiving holes 525, and passed into one of said corresponding fourth receiving holes 525 at a small-diameter section thereof; in addition, two sliding sleeves 572 are provided, which are positioned around two ends of the second sliding pin 57 respectively, and received in the slots 34 in a movable manner in order for allowing the long sections 522 of the second swinging bent arms 52 to be moved on the slots 34 together with the second sliding pin 57.

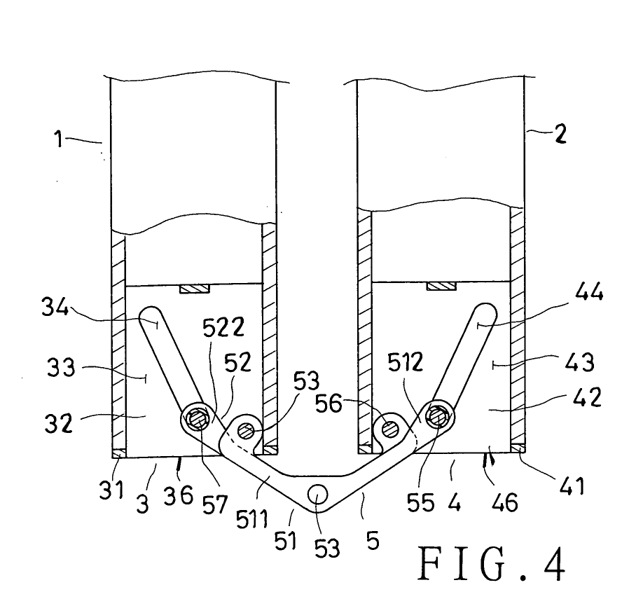

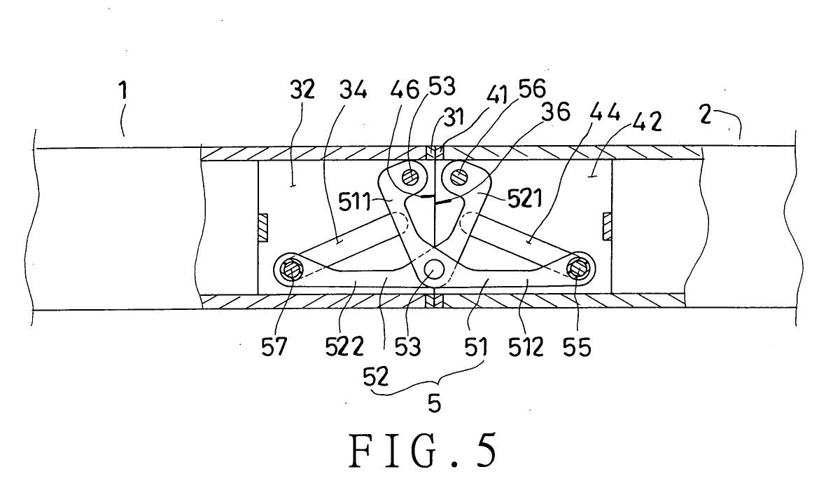

Therefore, the door plank 2 is allowed to pivot between an opened position and a closed one, with the first and the second sliding pins 55 and 57 moving on the slots 34 and 44 respectively; shown in FIG. 4 is a horizontal section of the door plank 2 in an opened position, wherein the first sliding pin 55 is located in front ends of the slots 34 of the corresponding hollow holding portion 32 of the first holding member 3, which are nearer to the corresponding hole 36 of the connecting panel 31 than rear ends of the slots 34, and the second sliding pin 57 is located in front ends of the slots 44 of the corresponding hollow holding portion 42 of the second holding member 4, which are nearer to the corresponding hole 46 of the connecting panel 41 than rear ends of the slots 44. And, shown in FIG. 5 is a horizontal section of the door plank 2 in a closed position, wherein the first sliding pin 55 is located in the rear ends of the slots 34, and the second sliding pin 57 is located in the rear ends of the slots 44 instead; thus, the hinges 5 are hidden within the door plank 2 and the doorframe 1.

From the above description, it can be seen that the present invention has the following advantages:

1. The first and the second pivotal pins are parallel with upright edges of the connecting panels of the first and the second holding members therefore the hinges will be in the correct position for use as soon as the first and the second holding members are inserted in the doorframe and the door plank respectively from the hollow holding portions thereof. In other words, it takes less time and labor to accurately install the hidden type of hinge of the present invention than it does to install the prior art.

2. The hinge structure is equipped with the ringed pads, which are positioned around the connecting pin, the sliding pins, and the pivotal pins to interpose between the swinging bent arms so as to reduce friction between the swinging bent arms. Therefore, the swinging bent arms of the hinge structure will move relatively smoothly when the door plank is being opened/closed.

What is claimed is:

1. A hidden type of hinge structure, used for pivoting a door plank to a doorframe, comprising
(a) a first holding member joined to the doorframe;
(b) a second holding member joined to the door plank;
each of the first and the second holding members including a connecting panel, and a plurality of hollow holding portions, which are arranged one on top of another next to one side of the connecting panel; each of the hollow holding portions having a receiving room therein; the connecting panel having a plurality of holes thereon, which are each faced and in open communication with a corresponding said receiving room; each of the hollow holding portions having a slot on each of a top and a bottom, which is above and under said receiving room; and
(c) a hinge pivoting the first and the second holding members together; the hinge being partly received in said first holding member, and partly received in said second holding member;
the hinge including:
a plurality of first swinging bent arms; each said first swinging bent arm including a short section, and a long section; each said first swinging bent arm having a first receiving hole on a tail end of the short section, and a second receiving hole on a tail end of the long section;
a plurality of second swinging bent arms; each said second swinging bent arms including a short section, and a long section; each said second swinging bent arm having a third receiving hole on a tail end of the short section, and a fourth receiving hole on a tail end of the long section;
each of said first and said second swinging bent arms having a connecting hole on a joint between the short section and the long section;
the first swinging bent arms being overlapped with and intersecting the second swinging bent arms such that all of the connecting holes are on a straight line; the swinging bent arms being arranged such that every two close ones of said connecting holes of the first swinging bent arms have one said connecting hole of the second swinging bent arms intervening between them;
a connecting pin passed through all of the connecting holes to pivot the first and the second swinging bent arms together;
a plurality of first ringed pads positioned around the connecting pin, and each interposed between two adjacent said connecting holes of said swinging bent arms;
a first pivotal pin, the first pivotal pin being passed through the first receiving holes, and secured at two ends thereof to a corresponding said hollow holding portion of said first holding member so as to pivot the first swinging bent arms to the first holding member;
a plurality of second ringed pads positioned around the first pivotal pin, and each interposed between two adjacent said first receiving holes of said short sections of said first swinging bent arms;
a first sliding pin, the first sliding pin being passed through the second receiving holes of the first swinging bent arms, and passed at two ends thereof into the slots of the top and the bottom of one corresponding said hollow holding portion of the second holding member so as to slide on the slots;
a plurality of third ringed pads positioned around the first sliding pin, and each interposed between two adjacent ones of the second receiving holes;
a second pivotal pin, the second pivotal pin being passed through said third receiving holes, and secured at two ends to a corresponding said hollow holding portion of said second holding member so as to pivot the second swinging bent arms to the second holding member;
a plurality of fourth ringed pads positioned around the second pivotal pin, and each interposed between two adjacent said third receiving holes of said short sections of said second swinging bent arms;
a second sliding pin, the second sliding pin being passed through the fourth receiving holes of the second swinging bent arms, and passed at two ends into the slots of the top and the bottom of one corresponding said hollow holding portion of the first holding member so as to slide on the slots; and
a plurality of fifth ringed pads positioned around the second sliding pin, and each interposed between two adjacent ones of the fourth receiving holes.

2. The hidden type of hinge structure as claimed in claim 1, wherein the first pivotal pin is parallel with an edge of the connecting panel of the first holding member.

3. The hidden type of hinge structure as claimed in claim 1, wherein the second pivotal pin is parallel with an edge of the connecting panel of the second holding member.

4. The hidden type of hinge structure as claimed in claim 1, wherein each said first ringed pad has a small-diameter section, which is passed into one of said connecting holes.

5. The hidden type of hinge structure as claimed in claim 1, wherein each said second ringed pad has a small-diameter section, which is passed into one of said first receiving holes.

6. The hidden type of hinge structure as claimed in claim 1, wherein the first pivotal pin is securely joined at two ends thereof to the top and the bottom of one said hollow holding portion of the first holding member by means of threaded elements.

7. The hidden type of hinge structure as claimed in claim 1, wherein each said third ringed pad has a small-diameter section, which is passed into one of said second receiving holes.

8. The hidden type of hinge structure as claimed in claim 1, wherein each said fourth ringed pad has a small-diameter section, which is passed into one of said third receiving holes.

9. The hidden type of hinge structure as claimed in claim 1, wherein the second pivotal pin is securely joined at two ends thereof to the top and the bottom of one said hollow holding portion of the second holding member by means of threaded elements.

10. The hidden type of hinge structure as claimed in claim 1, wherein each said fifth ringed pad has a small-diameter section, which is passed into one of said fourth receiving holes.
